(19) United States
(12) Patent Application Publication
(10) Pub. No.: US 2025/0349467 A1
(43) Pub. Date: Nov. 13, 2025

(54) MULTILAYER ELECTRONIC COMPONENT

(71) Applicant: SAMSUNG ELECTRO-MECHANICS CO., LTD., Suwon-si (KR)

(72) Inventor: Ki Hun JEON, Suwon-si (KR)

(73) Assignee: SAMSUNG ELECTRO-MECHANICS CO., LTD., Suwon-si (KR)

(21) Appl. No.: 19/078,538

(22) Filed: Mar. 13, 2025

(30) Foreign Application Priority Data
May 10, 2024 (KR) 10-2024-0062080

(51) Int. Cl. H01G 4/12; H01G 4/005; H01G 4/232; H01G 4/248; H01G 4/30

(52) U.S. Cl. CPC H01G 4/12; H01G 4/005; H01G 4/232; H01G 4/248; H01G 4/30

(57) ABSTRACT

A multilayer electronic component includes a multilayer portion having a dielectric layer and internal electrodes alternately disposed in a first direction. The multilayer portion has first and second surfaces opposing each other in the first direction, third and fourth surfaces opposing each other in a second direction perpendicular to the first direction, and fifth and sixth surfaces opposing each other in a third direction perpendicular to the first and second directions. A protective portion is disposed on the third and fourth surfaces, and external electrodes are disposed on the multilayer portion and the protective portion, electrically connected to the internal electrodes. The dielectric layer comprises first dielectric grains, and the protective portion comprises second dielectric grains with an average grain size smaller than that of the first dielectric grains.

### CROSS-REFERENCE TO RELATED APPLICATION(S)

This application claims the benefit of priority to Korean Patent Application No. 10-2024-0062080 filed on May 10, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on printed circuit boards of various types of electronic products such as image display devices, including a liquid crystal display (LCD) and a plasma display panel (PDP), computers, smartphones, and mobile phones, and serves to charge or discharge electricity therein or therefrom.

The multilayer ceramic capacitor may be used as a component of various electronic devices due to its small size, high capacitance, and ease of mounting. With the miniaturization and high-output power of various electronic devices, such as computers and mobile devices, the demand for miniaturized and high-capacitance multilayer ceramic capacitors has been increasing.

In order to increase capacitance per unit volume of a multilayer ceramic capacitor, a method of maximizing an area occupied by a capacitance formation portion in the entire component may be used. In this case, a thickness of a cover portion or margin portion, disposed on upper and lower surfaces or both side surfaces of the capacitance formation portion, may be reduced, resulting in degradation in moisture resistance reliability of a multilayer electronic component.

Additionally, when a multilayer ceramic capacitor is formed to include a minimum margin portion, a portion of an internal electrode may be exposed on a surface other than an external electrode coating surface during a process of polishing a multilayer portion, resulting in a short circuit in the multilayer ceramic capacitor.

Accordingly, there is demand for structural improvements to alleviate an issue associated with degradation in moisture resistance reliability of a multilayer ceramic capacitor and an issue associated with a short circuit of the multilayer ceramic capacitor caused by minimal formation of a margin portion.

### SUMMARY

An aspect of the present disclosure is to alleviate an issue associated with degradation in moisture resistance reliability of a multilayer ceramic capacitor caused by a reduced moisture permeation path.

Another aspect of the present disclosure is to alleviate an issue associated with a short circuit of a multilayer ceramic capacitor caused by minimal formation of a margin portion.

However, the aspects of the present disclosure are not limited to those described herein, and will be more easily understood in the course of describing specific example embodiments of the present disclosure.

According to an aspect of the present disclosure, there is provided a multilayer electronic component including a multilayer portion including a dielectric layer, an internal electrode disposed alternately with the dielectric layer in a first direction, first and second surfaces opposing each other in the first direction, third and fourth surfaces opposing each other in a second direction, perpendicular to the first direction, the third and fourth surfaces connected to at least a portion of the internal electrode, and fifth and sixth surfaces opposing each other in a third direction, perpendicular to the first and second directions, a protective portion disposed on the third and fourth surfaces, and an external electrode disposed on the multilayer portion and the protective portion, the external electrode connected to the internal electrode. The dielectric layer may include a first dielectric grain, and the protective portion includes a second dielectric grain. An average size of the second dielectric grain may be less than an average size of the first dielectric grain.

According to example embodiments of the present disclosure, a moisture permeation path may be lengthened, thereby improving moisture resistance reliability of a multilayer electronic component.

According to example embodiments of the present disclosure, minimal formation of a margin portion may be compensated, thereby reducing a short circuit occurrence rate of a multilayer ceramic capacitor.

However, the various beneficial advantages and effects of the present disclosure are not restricted to those described herein and will be more easily understood through the description of specific example embodiments.

### BRIEF DESCRIPTION OF DRAWINGS

The above and other aspects, features, and advantages of the present disclosure will be more clearly understood from the following detailed description, taken in conjunction with the accompanying drawings:

FIG. 1 is a schematic perspective view of a multilayer electronic component according to an example embodiment of the present disclosure.

FIG. 2 is a schematic perspective view of a configuration of a multilayer electronic component excluding an external electrode according to an example embodiment.

FIG. 3 is a schematic cross-sectional view taken along line I-I′ of FIG. 1.

FIG. 4 is a schematic cross-sectional view taken along line III-III′ of FIG. 1.

FIG. 5 is a schematic cross-sectional view taken along line II-II′ of FIG. 1.

FIG. 6 is an enlarged view of region “P” of FIG. 3.

FIG. 7 is a schematic exploded perspective view of a multilayer portion according to an example embodiment.

FIG. 8 illustrates a schematic coupling relationship between a multilayer portion and a protective portion according to an example embodiment.

FIG. 9 is a schematic perspective view of a configuration of a multilayer electronic component excluding an external electrode according to an example embodiment.

FIG. 10 illustrates a schematic coupling relationship between a multilayer portion and a protective portion according to an example embodiment; and

FIG. 11 is a schematic cross-sectional view taken along line IV-IV′ of FIG. 1.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments described herein. Additionally, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction may be defined as a lamination direction or a thickness (T) direction, a second direction may be defined as a length (L) direction, and a third direction may be defined as a width (W) direction.

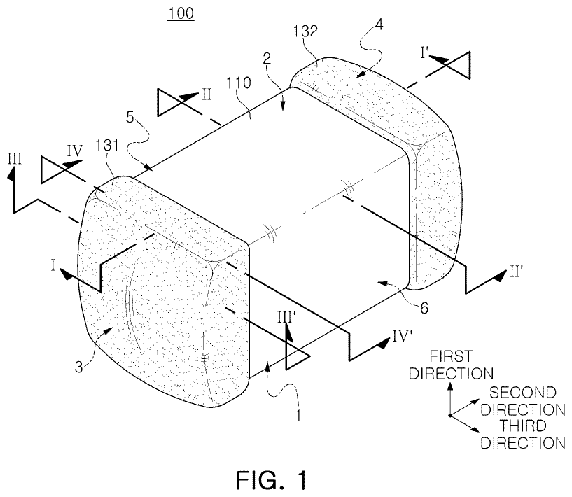

FIG. 1 is a schematic perspective view of a multilayer electronic component according to an example embodiment of the present disclosure.

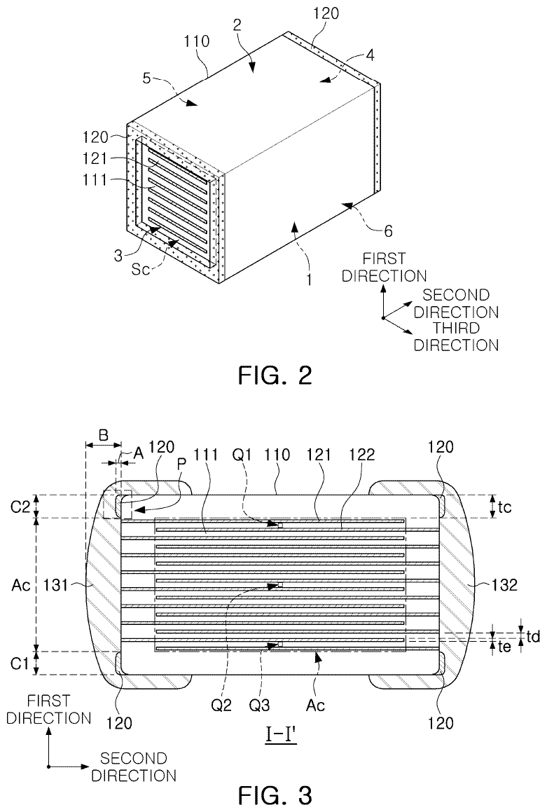

FIG. 2 is a schematic perspective view of a configuration of a multilayer electronic component excluding an external electrode according to an example embodiment.

FIG. 3 is a schematic cross-sectional view taken along line I-I′ of FIG. 1.

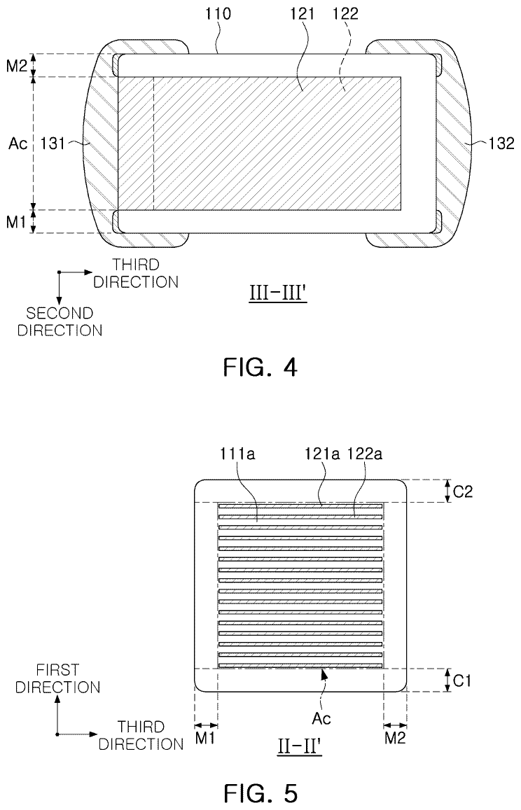

FIG. 4 is a schematic cross-sectional view taken along line III-III′ of FIG. 1.

FIG. 5 is a schematic cross-sectional view taken along line II-II′ of FIG. 1.

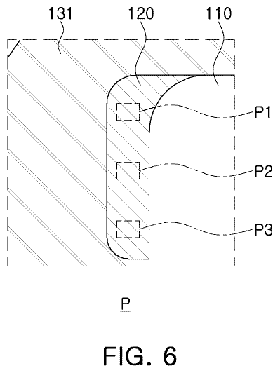

FIG. 6 is an enlarged view of region “P” of FIG. 3.

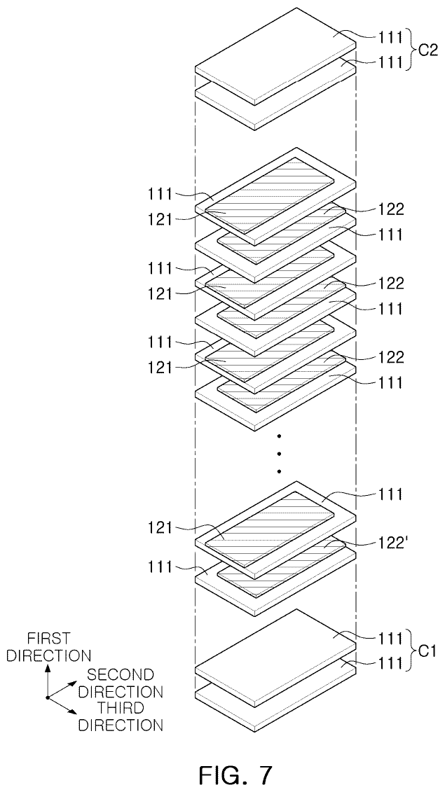

FIG. 7 is a schematic exploded perspective view of a multilayer portion according to an example embodiment.

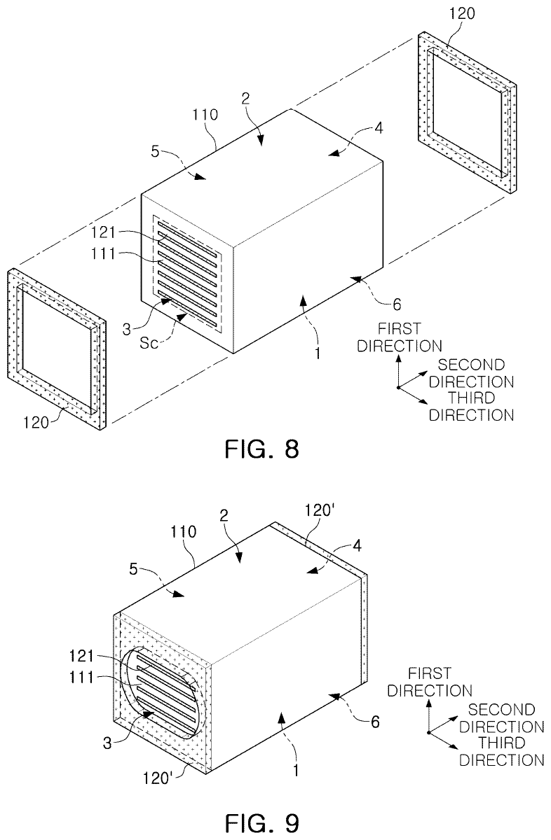

FIG. 8 illustrates a schematic coupling relationship between a multilayer portion and a protective portion according to an example embodiment.

FIG. 9 is a schematic perspective view of a configuration of a multilayer electronic component excluding an external electrode according to an example embodiment.

FIG. 10 illustrates a schematic coupling relationship between a multilayer portion and a protective portion according to an example embodiment.

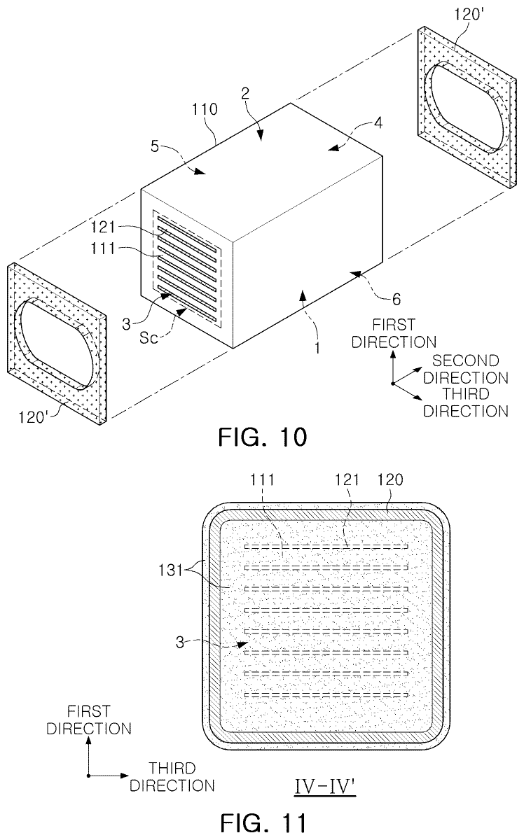

FIG. 11 is a schematic cross-sectional view taken along line IV-IV′ of FIG. 1.

Hereinafter, a multilayer electronic component 100 according to an example embodiment of the present disclosure and various examples will be described in detail with reference to FIGS. 1 to 11. Additionally, a multilayer ceramic capacitor (hereinafter referred to as “MLCC”) is described as an example of the multilayer electronic component, but the present disclosure is not limited thereto.

A multilayer electronic component 100 according to an example embodiment of the present disclosure may include a multilayer portion 100 including a dielectric layer 111, internal electrodes 121 and 122 disposed alternately with the dielectric layer in a first direction, first and second surfaces 1 and 2 opposing each other in the first direction, third and fourth surfaces 3 and 4 opposing each other in a second direction, perpendicular to the first direction, the third and fourth surfaces connected to at least a portion of the internal electrode, and fifth and sixth surfaces 5 and 6 opposing each other in a third direction, perpendicular to the first and second directions, a protective portion 120 disposed on the third and fourth surfaces, and external electrodes 131 and 132 disposed on the multilayer portion and the protective portion, the external electrodes connected to the internal electrodes. The dielectric layer may include a first dielectric grain, and the protective portion may include a second dielectric grain. An average size of the second dielectric grain may be less than an average size of the first dielectric grain.

Hereinafter, respective components included in the multilayer electronic component 100 according to an example embodiment of the present disclosure will be described.

The multilayer portion 110 may include a dielectric layer 111 and internal electrodes 121 and 122 disposed alternately with the dielectric layer 111 in a first direction.

A specific shape of the multilayer portion 110 is not limited. However, as illustrated, the multilayer portion 110 may have a hexahedral shape or a shape similar thereto. During a sintering process, ceramic powder particles included in the multilayer portion 110 may shrink, such that the multilayer portion 110 may not have a hexahedral shape having perfectly straight lines, but may have a substantially hexahedral shape.

In an example embodiment, a lamination direction of the dielectric layer 111 and the internal electrodes 121 and 122 may be defined as a first direction, a direction, perpendicular to the first direction, may be defined as a second direction, and a direction, perpendicular to the first direction and the second direction, may be defined as a third direction.

The multilayer portion 110 may have first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first and second surfaces 1 and 2 and to the third and fourth surfaces 3 and 4, while opposing each other in a third direction.

In this case, the third and fourth surfaces 3 and 4 may be connected to at least portions of the internal electrodes 121 and 122. Specifically, the third surface 3 may be connected to a first internal electrode 121, and the fourth surface 4 may be connected to a second internal electrode 122.

Additionally, the fifth and sixth surfaces 5 and 6 may be disposed to be spaced apart from the internal electrodes 121 and 122. Specifically, the fifth and sixth surfaces 5 and 6 may be disposed to be spaced apart from both ends of the first and second internal electrodes 121 and 122 in the third direction.

As margin regions where the internal electrodes 121 and 122 are not disposed on the dielectric layer 111 overlap each other, a step may be caused by thicknesses of the internal electrodes 121 and 122, such that a corner, connecting the first surface and the third to fifth surfaces to each other, and/or a corner, connecting the second surface and the third to fifth surfaces to each other, may shrink toward a central portion of the multilayer portion 110 in the first direction, relative to the first surface or the second surface. Alternatively, due to a shrinkage behavior of the multilayer portion during a sintering process, a corner, connecting the first surface 1 and the third to sixth surfaces 3, 4, 5, and 6 to each other, and/or a corner, connecting the second surface 2 and the third to sixth surfaces 3, 4, 5, and 6 to each other, may shrink toward the central portion of the multilayer portion 110 in the first direction, relative to the first surface or the second surface. Alternatively, in order to prevent chipping defects or the like, an additional process may be performed to round corners connecting respective surfaces of the multilayer portion 110 to each other. Accordingly, a corner, connecting a first surface and third to sixth surfaces to each other, and/or a corner, connecting a second surface and the third to sixth surfaces to each other, may have a round shape.

A plurality of dielectric layers 111, in the multilayer portion 110 may be in a sintered state, with adjacent dielectric layers 111 integrated such that boundaries between them are not readily apparent without using a scanning electron microscope (SEM). The number of laminated dielectric layers is not limited and may be determined based on the size of the multilayer electronic component. For example, the multilayer portion may be formed by laminating 400 or more dielectric layers.

The dielectric layer 111 may be formed by preparing a ceramic slurry containing ceramic powder particles, an organic solvent and a binder, coating the slurry on a carrier film and drying the same to prepare a ceramic green sheet, and then sintering the ceramic green sheet. The ceramic powder particles are not limited as long as sufficient capacitance is obtainable therewith, and may be, for example, barium titanate-based (BaTiO₃)-based powder particles. As a more specific example, the ceramic powder particles may be CaZrO₃-based paraelectric powder particles, or similar materials. As a more specific example, the barium titanate-based (BaTiO₃)-based powder particles may be at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and the CaZrO₃-based paraelectric powder particles may be (Ca₁₋ₓSrₓ)(Zr_{1-y}Ti_{y})O₃ (0<x<1, 0<y<1).

Accordingly, the dielectric layer 111 may include at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1).

An average thickness (td) of the dielectric layer 111 is not limited.

In order to achieve high capacitance and miniaturization of the multilayer electronic component 100, the average thickness (td) of the dielectric layer 111 may be 0.35 μm or less. In order to improve reliability of the multilayer electronic component 100 under high temperature and high pressure, the average thickness (td) of the dielectric layer 111 may be 3 μm or more.

The thickness (td) of the dielectric layer 111 may be measured by scanning, with an SEM, an image of a cross-section (L-T cross-section) of the multilayer portion 110 in third and first directions.

For example, with respect to a total of five dielectric layers, one dielectric layer at a reference point where a central line of the multilayer portion 110 in the length direction and a central line of the multilayer portion in the thickness direction meet, two dielectric layers above this reference layer, and two dielectric layers below it-five points may be set. These include the reference point, two points to the left of the reference point, and two points to the right, all equally spaced apart from each other. The thicknesses at these points may be measured to obtain an average value. The thickness (td) of the dielectric layer 111 may be this average value.

The multilayer portion 110 may include a capacitance formation portion Ac in which the dielectric layer 111 and the internal electrodes 121 and 122 are alternately disposed to form capacitance. Specifically, the capacitance formation portion Ac may be a region having capacitance by including the first internal electrode 121 and the second internal electrode 122 disposed to oppose each other with the dielectric layer 111 interposed between them.

The capacitance formation portion Ac may be a portion contributing to forming capacitance of a capacitor, and may be formed by repeatedly laminating the first and second internal electrodes 121 and 122 with the dielectric layer 111 interposed therebetween. In addition, the capacitance formation portion Ac may have an uppermost end in the first direction on which the first internal electrode 121, and a lowermost end in the first direction on which the second internal electrode 122 is disposed.

The internal electrodes 121 and 122 may include the first internal electrode 121 and the second internal electrode 122. The first and second internal electrodes 121 and 122 may be alternately disposed to oppose each other with the dielectric layer 111, included in the multilayer portion 110, interposed between them, and may respectively be exposed to the third and fourth surfaces 3 and 4 of the multilayer portion 110.

The first internal electrode 121 may be spaced apart from the fourth surface 4 and connected to the third surface 3, and the second internal electrode 122 may be spaced apart from the third surface 3 and connected to the fourth surface 4. The first external electrode 131 may be disposed on the third surface 3 of the multilayer portion to be connected to the first internal electrode 121, and the second external electrode 132 may be disposed on the fourth surface 4 of the multilayer portion to be connected to the second internal electrode 122.

That is, the first internal electrode 121 may not be connected to the second external electrode 132 and connected to the first external electrode 131, and the second internal electrode 122 may not be connected to the first external electrode 131 and connected to the second external electrode 132. Accordingly, the first internal electrode 121 may be spaced apart from the fourth surface 4 by a predetermined distance, and the second internal electrode 122 may be spaced apart from the third surface 3 by a predetermined distance.

A conductive metal used in the internal electrodes 121 and 122 may include at least one of Ni, Cu, Pd, Ag, Au, Pt, In, Sn, Al, Ti, and their alloys; however, the present disclosure is not limited thereto.

An average thickness (the) of each of the internal electrodes 121 and 122 is not limited and may vary according to a purpose. In order to miniaturize the multilayer electronic component 100, the average thickness (the) of each of the internal electrodes 121 and 122 may be 0.35 μm or less. In order to improve reliability of the multilayer electronic component 100 under high temperature and high pressure, the average thickness (the) of each of the internal electrodes 121 and 122 may be 3 μm or more.

For example, with respect to a total of five internal electrode layers including one internal electrode layer at a reference point at which a central line of the multilayer portion 110 in a length direction and a central line of the multilayer portion in a thickness direction meet each other, two internal electrode layers above the one internal electrode layer, and two internal electrode layer below the one internal electrode layer, among internal electrode layers extracted from an image obtained by scanning a cross-section in the length and thickness directions (L-T) of a central portion of the multilayer portion in a width direction, five points, including the reference point, two left points relative to the reference point, and two right points relative to the reference point, may be set to be equally spaced apart from each other, and then thicknesses of respective points may be measured to obtain an average value thereof. The thickness (the) of each of the internal electrode 121 and 122 may be the average value.

A shape of each of the internal electrodes 121 and 122 is not limited.

However, when a size of each of the internal electrodes 121 and 122 in the third direction has a bottleneck shape decreasing toward the third surface 3 or the fourth surface 4, it may be advantageous to secure moisture resistance reliability as a result of lengthening a permeation path of external moisture to the internal electrodes 121 and 122.

When the bottleneck shape is not applied to the internal electrode, capacitance per unit volume of the multilayer electronic component 100 may be increased, and a thickness variation of the internal electrode may be reduced, resulting in an improvement in BDV properties. However, when the bottleneck shape is not applied to the internal electrode, a permeation path of external moisture may be shortened as compared to a case in which the bottleneck shape is applied, and thus it may be difficult to secure moisture resistance reliability.

However, according to an example embodiment of the present disclosure, the protective portion 120, including dielectric grains having an average grain size less than that of the dielectric layer 111, may be formed on the third and fourth surfaces 3 and 4 of the multilayer portion 110. Thus, excellent moisture resistance reliability may be secured even when a bottleneck pattern is not applied to the internal electrode. That is, when the bottleneck pattern is not applied to the internal electrode, an effect of improving moisture resistance reliability of the present disclosure may be further improved, capacitance per unit volume of the multilayer electronic component 100 may be increased as compared to a case in which the bottleneck pattern is applied, and BDV properties may also be improved.

“When the bottleneck pattern is not applied to the internal electrode” may mean that the internal electrodes 121 and 122 have a rectangular shape in a cross-section in the second and third directions of the multilayer portion 110, or that a size of each of the internal electrodes 121 and 122 in the third direction is substantially equal in the second direction. In this case, “the size of each of the internal electrodes 121 and 122 in the third direction is substantially equal in the second direction” may mean that the size of each of the internal electrodes 121 and 122 in the third direction vary within a deviation range of −2% to +2% in the second direction.

Referring to FIGS. 3 and 5, cover portions C1 and C2 may be disposed on both surfaces of the capacitance formation portion Ac in the first direction.

The cover portions C1 and C2 primarily serve to prevent damage to the internal electrode caused by physical or chemical stress.

The cover portions C1 and C2 may include a material the same as that of the dielectric layer 111. That is, the cover portions 112 and 113 may include a ceramic material, for example, a barium titanate (BaTiO₃)-based ceramic material.

Referring to FIG. 7, the cover portions C1 and C2 may be formed by additionally laminating the dielectric layer 111 onto both surfaces of the capacitance formation portion, in which the internal electrodes 121 and 122 and the dielectric layer 111 are alternately disposed, in the first direction, but the present disclosure is not limited thereto.

A thickness of each of the cover portions C1 and C2 may not need be limited. For example, an average thickness (tc) of each of the cover portions 112 and 113 may be 0.25 times or less of a maximum size of the multilayer electronic component 100 in the first direction.

When the average thickness of each cover portion C1 and C2 is 0.25 times or less than the maximum size of the multilayer electronic component 100 in the first direction, the path through which external moisture or plating solution permeates into the cover portions C1 and C2 may be reduced. Consequently, it may be difficult to secure the moisture resistance reliability of the multilayer electronic component 100. However, according to an example embodiment of the present disclosure, the protective portion 120, including dielectric grains having an average grain size less than that of the dielectric layer 111, may be formed on the third and fourth surfaces 3 and 4 of the multilayer portion 110. Thus, excellent moisture resistance reliability may be secured even when the average thickness of each of the cover portions C1 and C2 is 0.25 times or less of the maximum size of the multilayer electronic component 100 in the first direction. That is, when the average thickness of each of the cover portions C1 and C2 is 0.25 times or less of the maximum size of the multilayer electronic component 100 in the first direction, an effect of improving moisture resistance reliability of the present disclosure may be more remarkable.

The average thickness (tc) of each of the cover portions C1 and C2 may refer to average size of each of the cover portions C1 and C2 in the first direction, and may be an average value obtained by averaging sizes of each of the cover portions C1 and C2 in the first direction, measured at five equally spaced points of an upper portion or lower portion of the capacitance formation portion Ac.

In addition, referring to FIGS. 4 and 5, margin portions M1 and M2 may be disposed on both surfaces of the capacitance formation portion Ac in the third direction.

The margin portions M1 and M2 may include a first margin portion M1 disposed on the fifth surface 5 of the multilayer portion 110, and a second margin portion M2 disposed on the sixth surface 6 of the multilayer portion 110. That is, the margin portions 114 and 115 may be disposed on both end surfaces of the ceramic multilayer portion 110 in a width direction.

As illustrated in FIG. 5, the margin portions 114 and 115 may refer to regions between both distal ends of the first and second internal electrodes 121 and 122 and a boundary surface of the multilayer portion 110 in a cross-section of the multilayer portion 110 in a width-thickness (W-T) direction.

The margin portions M1 and M2 primarily serve to prevent damage to the internal electrodes caused by physical or chemical stress.

The margin portions M1 and M2 may be formed by forming an internal electrode by coating a conductive paste on a ceramic green sheet, except for a portion of the ceramic green sheet on which a margin portion is to be formed, but the present disclosure is not limited thereto, and may be formed by coating a ceramic slurry for forming a margin portion on a side surface of the multilayer portion 110 and then performing sintering thereon, or pressing a ceramic green sheet for forming a margin portion to attach the ceramic green sheet to the side surface of the multilayer portion 110 and then performing sintering thereon. A material of the first and second side margin portions 114 and 115 is not limited, and may be the same as that of the dielectric layer 111, but the present disclosure is not limited thereto, and may be different from that of the dielectric layer 111. As a result, the first and second side margin portions 114 and 115 may have a composition different from that of the dielectric layer 111.

A width of each of the margin portions M1 and M2 may not need be limited. For example, an average width of each of the margin portions M1 and M2 may be 0.25 times or less of a maximum size of the multilayer electronic component 100 in the third direction.

When the average width of each of the margin portions M1 and M2 is 0.25 times or less of the maximum size of the multilayer electronic component 100 in the third direction, a path through which external moisture or plating solution permeates into the margin portions M1 and M2 may be reduced, and thus, it may be difficult to secure moisture resistance reliability of the multilayer electronic component 100. However, in an example embodiment of the present disclosure, the protective portion 120, comprising dielectric grains with an average grain size smaller than that of the dielectric layer 111, may be formed on the third and fourth surfaces 3 and 4 of the multilayer portion 110. This ensures excellent moisture resistance reliability even when the average thickness of each margin portion M1 and M2 is 0.25 times or less than the maximum size of the multilayer electronic component 100 in the third direction. That is, when the average thickness of each of the margin portions M1 and M2 is 0.25 times or less of the maximum size of the multilayer electronic component 100 in the third direction, an effect of improving moisture resistance reliability of the present disclosure may be more remarkable.

The average widths of the margin portions M1 and M2 may refer to an average size of a region, in which the internal electrode is spaced apart from the fifth surface, in the third direction, and an average size of a region, in which the internal electrode is spaced apart from the sixth surface, in the third direction, and may be average values obtained by averaging sizes of each of the margin portions M1 and M2, measured at five equally spaced points of an side surface of the capacitance formation portion Ac.

Referring to FIG. 8, the protective portion 120 may be disposed on the third and fourth surfaces 3 and 4 of the multilayer portion 110. These surfaces are connected to one end of the internal electrodes 121 and 122 to increase the permeation path of external moisture.

A material of the protective portion 120 is not limited, but the protective portion 120 may include one or more dielectric materials, among BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1).

According to an example embodiment of the present disclosure, the multilayer portion 110 may include dielectric grains. Only the dielectric layer may be present in the cover portion or margin portion, a region in which the internal electrode of the multilayer portion 110 is not present, such that sintering driving force may be weaker than that of the capacitance formation portion Ac including the internal electrode. Accordingly, when the multilayer portion 110 is sintered, the cover portion or the margin portion may form a structure that is not denser than that of the capacitance formation portion Ac.

Accordingly, in an example embodiment of the present disclosure, the protective portion 120, having a dielectric grain smaller than that of the dielectric layer 111, may be formed on the third and fourth surfaces 3 and 4 of the multilayer portion 110 to increase a permeation path of external moisture, thereby further improving moisture resistance reliability of the multilayer electronic component 100.

A ratio of an average size of a second dielectric grain to an average size of a first dielectric grain is not limited. However, when the ratio of the average size of the second dielectric grain to the average size of the first dielectric grain is less than 0.10, an excessive size difference may occur between the first dielectric grain and the second dielectric grain, such that pores may be generated due to a sintering mismatch. Accordingly, moisture resistance reliability may be degraded, and an issue associated with occurrence of cracks or the like may occur. When the ratio of the average size of the second dielectric grain to the average size of the first dielectric grain is greater than 0.80, the size of the first dielectric grain and the size of the second dielectric grain may not be greatly different from each other, and thus an effect of blocking permeation of external moisture may be slightly insufficient. Accordingly, the ratio of the average size of the second dielectric grain to the average size of the first dielectric grain may be 0.10 or more and 0.80 or less.

A method of measuring the ratio of the average size of the second dielectric grain to the average size of the first dielectric grain is not limited.

First, the average size of the first dielectric grain may be calculated by averaging the sizes of dielectric grains measured in the central regions Q1, Q2, and Q3 of the dielectric layer. These measurements are taken from a cross-section of the multilayer electronic component in the first and second directions (FIG. 3), obtained by polishing the multilayer electronic component to its central portion in the third direction.

Each region for measuring the average size of the first dielectric grain may refer to a region having a size in the first direction X a size in the second direction=a region having a size of 5 μm×5 μm measured with an SEM in the cross-section, but the present disclosure is not limited thereto. In addition, an average size of a dielectric grain in each region may be measured using a method of measuring short-axis lengths and long-axis lengths of any ten or more grains in each region, or a method of measuring an area of the grains in pixels and converting the area into an equivalent-circle diameter, but the present disclosure is not limited thereto. The average size of the first dielectric grain may be further generalized by measuring the sizes of the first dielectric grain in the central regions Q1, Q2, and Q3 of the dielectric layer. Region Q1 is located at the uppermost end of the capacitance formation portion (Ac) in the first direction, Q2 is at the center, and Q3 is at the lowermost end. The measured sizes from these regions may then be averaged.

Next, the average size of the second dielectric grain may be an average value obtained by averaging sizes of a dielectric grain measured in central regions P1, P2, and P3 (FIG. 6) obtained by dividing a region, in which the protective portion 150 is formed, into three portions in a cross-section of the multilayer electronic component in the first and second directions (FIG. 3), obtained by polishing the multilayer electronic component up to a central portion of the multilayer electronic component in the third direction.

Similarly, each region for measuring the average size of the second dielectric grain may refer to a region having a size in the first direction X a size in the second direction=a region having a size of 5 μm×5 μm measured with an SEM in the cross-section, but the present disclosure is not limited thereto. In addition, an average size of a dielectric grain in each region may be measured using a method of measuring short-axis lengths and long-axis lengths of any ten or more grains in each region, or a method of measuring an area of the grains in pixels and converting the area into an equivalent-circle diameter, but the present disclosure is not limited thereto. The average size of the second dielectric grain may be further generalized by respectively measuring sizes of the second dielectric grain in the regions P1, P2, and P3 of the protective portion 120, and averaging the sizes.

In an example embodiment, the protective portion 120 may cover a region of the third surface 3 and the fourth surface 4, excluding an end surface Sc of the internal electrode. Accordingly, connection between the external electrodes 131 and 132 and the internal electrodes 121 and 122 may be improved.

Referring to FIG. 2, one end of the internal electrode in the second direction, connected to the third surface 3 or fourth surface 4, is referred to as the end portion of the internal electrode. The end surface Sc of the internal electrode refers to a rectangular region between the uppermost and lowermost ends of the end portion in the first direction and the region between both line segments connecting the distal end of the end portion in the third direction.

The end surface Sc of the internal electrode may refer to a region in which the external electrodes 131 and 132 are in direct contact with one ends of the internal electrodes 121 and 122 in the second direction. Accordingly, according to an example embodiment, when the protective portion 120, covering a region of the third surface 3 and the fourth surface 4 excluding the end surface Sc of the internal electrode, is applied, the external electrodes 131 and 132 may be formed on all ends of the internal electrode positioned on the end surface Sc of the internal electrode, thereby improving connection between the external electrodes 131 and 132 and the internal electrodes 121 and 122.

Referring to FIG. 2, a maximum size of the external electrodes 131 and 132 in the second direction is indicated by B, and a maximum size of the protective portion 120 in the second direction is indicated by A.

When the protective portion 120, containing dielectric grains smaller than those of the dielectric layer 111, is formed on the third surface 3 and the fourth surface 4, the occurrence of short circuits in the multilayer electronic component may be alleviated, and moisture resistance reliability may be improved.

However, when the protective portion 120 is formed to have an excessively long size compared to a maximum size (B) of each of the external electrodes 131 and 132 in the second direction, the external electrodes 131 and 132 may be trapped in the protective portion 120 and thus may not be mounted on a substrate. Accordingly, a ratio (A/B) of a maximum size (A) of the protective portion 120 in the second direction to the maximum size (B) of the external electrode in the second direction may be appropriately adjusted to improve mountability of the multilayer electronic component, improve moisture resistance reliability, and prevent short circuit from occurring.

Specifically, the ratio (A/B) of the maximum size (A) of the protective portion 120 in the second direction to the maximum size (B) of the external electrodes in the second direction may be greater than 0.18 and less than 1.00, and more preferably between 0.25 and 0.75.

When the ratio (A/B) of the maximum size (A) of the protective portion 120 in the second direction to the maximum size (B) of the external electrode in the second direction is 0.18 or less, mountability may be secured. However, as a result of insufficiently forming the protective portion 120, it may be difficult to secure an effect of preventing a short circuit from occurring and an effect of improving moisture resistance reliability.

Accordingly, when the ratio (A/B) of the maximum size (A) of the protective portion 120 in the second direction to the maximum size (B) of the external electrode in the second direction is greater than 0.18, improvements in mountability, moisture resistance reliability, and prevention of short circuits may be simultaneously achieved.

However, when the ratio (A/B) of the maximum size (A) of the protective portion 120 in the second direction to the maximum size (B) of the external electrode in the second direction is 1.00, the multilayer electronic component 100 may not be mounted on the substrate due to excessive formation of the protective portion 120.

Accordingly, in order to secure mountability, the ratio (A/B) of the maximum size (A) of the protective portion 120 in the second direction to the maximum size (B) of the external electrode in the second direction may be less than 1.00.

A method of measuring the maximum size (A) of the protective portion 120 in the second direction and the maximum size (B) of each of the external electrodes 131 and 132 in the second direction is not limited.

The maximum size (A) of the protective portion 120 in the second direction and the maximum size (B) of each of the external electrodes 131 and 132 in the second direction may refer to values obtained by measuring horizontal distances in the second direction from the third surface 3 or the fourth surface 4 to an outermost point of the protective portion 120 and an outermost point of each of the external electrodes 131 and 132 in the second direction using an SEM, an optical microscope (OM), or the like, in a cross-section of the multilayer electronic component 100 in the first and second directions, obtained by polishing the multilayer electronic component up to a central portion of the multilayer electronic component in the third direction.

The maximum size (A) of the protective portion 120 in the second direction may be adjusted according to a thickness of a ceramic green sheet for forming a protective portion attached to the third surface 3 or the fourth surface 4 of the multilayer portion 110, and the maximum size (B) of the external electrode in the second direction may be adjusted according to a degree of dipping of an external electrode paste before the external electrodes 131 and 132 are sintered.

The protective portion 120 may be disposed on side surfaces of the cover portions C1 and C2 in the second direction and side surfaces of the margin portions M1 and M2 in the second direction according to an example embodiment. Specifically, the protective portion 120 may be disposed to cover the side surfaces of the cover portions C1 and C2 and the margin portions M1 and M2 in the second direction, and thus an effect of improving moisture resistance reliability according to the present disclosure may be more remarkable.

A shape of the protective portion 120 is not limited. In FIGS. 1 to 8, a region of the third surface 3 and the fourth surface 4, not covered by the protective portion 120, is expressed as having a rectangular shape, but is not limited thereto, and may have various shapes. For example, referring to FIGS. 9 and 10, a region of the third surface 3 and the fourth surface 4, not covered by the protective portion 120′, may have an oval shape or a circular shape.

Referring to FIG. 11, an area of a region of the third surface 3 of the multilayer portion 110, not covered by the protective portion 120, may be greater than an area of a region of the third surface 3, covered by the protective portion 120. Accordingly, an effect of improving moisture resistance of the present disclosure may be secured, and an area of the first external electrode 131 is in contact with the first internal electrode 121 may be sufficiently secured to improve electrical connection between the first external electrode 1310 and the first internal electrode 121. A relationship with the protective layer 120 is described relative to the third surface 3, the relationship with the protective layer 120 may be similarly understood relative to the fourth surface 4. Specifically, the area of the fourth surface 4 of the multilayer portion 110 not covered by the protective portion 120 may be greater than the area of the fourth surface 4 covered by the protective portion 120.

The external electrodes 131 and 132 may be disposed on the third and fourth surfaces 3 and 4 of the multilayer portion 110. In addition, referring to FIGS. 3 and 4, the external electrodes 131 and 132 may be disposed on the protective portion 120, and may cover the protective portion 120.

Referring to FIG. 1, the external electrodes 131 and 132 may be respectively disposed on the third and fourth surfaces 3 and 4 of the multilayer portion 110, and may include first and second external electrodes 131 and 132 respectively connected to the first and second internal electrodes 121 and 122.

In the present example embodiment, a structure is described in which the multilayer electronic component 100 has two external electrodes 131 and 132, but the number or shapes of the external electrodes 131 and 132 may be changed depending on shapes of the internal electrodes 121 and 122 or other purposes.

The external electrodes 131 and 132 may be made of any electrically conductive material, such as a metal. The specific material may be selected based on electrical properties, structural stability, or similar considerations. Additionally, the external electrodes 131 and 132 may have a multilayer structure.

For example, the external electrodes 131 and 132 may include an electrode layer disposed on the multilayer portion 110, and a plating layer formed on the electrode layer.

As a more specific example of the electrode layer, the electrode layer may be a sintered electrode including a conductive metal and glass, or a resin-based electrode including a conductive metal and a resin.

Additionally, the electrode layer may consist of a sintered electrode and a resin-based electrode sequentially formed on the multilayer portion. The electrode layer may also be formed by transferring a sheet containing a conductive metal onto the multilayer portion or onto the sintered electrode.

A material having excellent electrical conductivity may be used as a conductive metal, included in the electrode layer, and is not limited. For example, the conductive metal may be one or more of nickel (Ni), copper (Cu), and an alloy thereof.

The plating layer may serve to improve mounting properties. A type of the plating layer is not limited, and may be a plating layer including at least one of Ni, Sn, Pd, and alloys thereof, and may be formed of a plurality of layers.

As a more specific example, the plating layer may be a Ni plating layer or a Sn plating layer, may be a form in which a Ni plating layer and a Sn plating layer are sequentially formed on the electrode layer, or may be a form in which a Sn plating layer, a Ni plating layer, and a Sn plating layer are sequentially formed. In addition, the plating layer may include a plurality of Ni plating layers and/or a plurality of Sn plating layers.

The size of the multilayer electronic component 100 is not restricted.

For example, the multilayer electronic component 100 may have a size of 0201 (length×width, 0.2 mm×0.1 mm) or less to simultaneously achieve miniaturization and high capacitance, and may have a size of 3216 (length×width, 3.2 mm×1.6 mm) or more for a product significantly requiring reliability in a high-temperature and high-pressure environment, but the present disclosure is not limited thereto.

Here, a length of the multilayer electronic component 100 refers to its maximum size in the second direction, the thickness refers to its maximum size in the first direction, and the width refers to its maximum size in the third direction.

### EXAMPLES

Table 1 below indicates results of evaluating mountability, a short circuit occurrence rate, and moisture resistance reliability according to the ratio (A/B) of the maximum size (A) of the protective portion 120 in the second direction to the maximum size (B) of the external electrode in the second direction.

A sample of a multilayer electronic component, on which a properties evaluation was performed during a test process of Table 1, was manufactured by printing an internal electrode on a dielectric molding sheet to manufacture a multilayer bar, cutting the multilayer bar, pressing a ceramic green sheet for forming a protective portion to attach the ceramic green sheet to a side surface of the cut multilayer bar, and plasticizing and re-oxidizing the ceramic green sheet together with the multilayer bar in a plastic and reducing atmosphere.

In this case, an A/B value was adjusted by varying a thickness of the ceramic green sheet for forming a protective portion and a degree of dipping of an external electrode paste for each test number, and other conditions are the same.

The maximum size (A) of the protective portion 120 in the second direction and the maximum size (B) of each of the external electrodes 131 and 132 in the second direction were obtained by measuring horizontal distances in the second direction from the third surface 3 or the fourth surface 4 to an outermost point of the protective portion 120 and an outermost point of each of the external electrodes 131 and 132 in the second direction using an OM, in a cross-section of the multilayer electronic component 100 in the first and second directions, obtained by polishing the multilayer electronic component up to a central portion of the multilayer electronic component in the third direction.

Mountability evaluation was performed by soldering 400 multilayer electronic components onto one substrate, followed by a reflow process. The substrate was then inverted, and mountability was rated as NG (X) if 200 or more multilayer electronic components were dislodged, and OK (∘) if fewer than 200 components were dislodged.

In a short circuit occurrence rate evaluation, capacitances of 30 multilayer electronic components were measured using a capacitance measurer, and a multilayer electronic component having a disposition factor (DF) of 0.1 or more was determined as a short circuit, and a ratio of multilayers electronic components having a short circuit to the 30 multilayer electronic components was expressed as a percentage.

A moisture resistance reliability evaluation was performed in 1,200 samples per test number under conditions of 1.2 Vr, 85° C., and a relative humidity of 85%, and a sample having an insulation resistance value fell 100 times or more from an initial insulation resistance value was determined as defective.

TABLE 1

| | | | | | | Moisture |
|---|---|---|---|---|---|---|
| | | | | | | resistance |
| | | | | | | reliability (the |
| | | | | | | number of |
| | | | | | Short circuit | defects/the |
| | | | | | occurrence | number of |
| Test nos. | A(μm) | B(μm) | A/B | Mountability | rate(%) | samples) |
| 1 | 0 | 40 | 0 | ◯ | 100 | — |
| 2 | 2 | 40 | 0.05 | ◯ | 20 | — |
| 3 | 4 | 40 | 0.10 | ◯ | 7 | 6/1200 |
| 4 | 7 | 40 | 0.18 | ◯ | 3 | 3/1200 |
| 5 | 10 | 40 | 0.25 | ◯ | 0 | 0/1200 |
| 6 | 15 | 40 | 0.38 | ◯ | 0 | 0/1200 |
| 7 | 20 | 40 | 0.50 | ◯ | 0 | 0/1200 |
| 8 | 25 | 40 | 0.63 | ◯ | 0 | 0/1200 |
| 9 | 30 | 40 | 0.75 | ◯ | 0 | 0/1200 |
| 10 | 40 | 40 | 1 | X | 0 | 0/1200 |

Test No. 1 is a case in which a protective portion is not formed, and it may be confirmed that a short circuit occurrence rate is 100%.

Test No. 2 is a case in which A/B is 0.05, and it may be confirmed that a short circuit occurrence rate is 20%.

Test Nos. 3 to 4 are cases in which A/B is 0.18 or less or less than 0.25. It may be confirmed that sufficient moisture resistance reliability is not securable even when a short circuit occurrence rate decreases as A/B increases.

Test Nos. 5 to 9 are cases in which A/B is greater than 0.18 and less than 1.00, or 0.25 or more and 0.75 or less, and it may be confirmed that a short circuit occurrence rate is 0%, and mountability and moisture resistance reliability are excellent.

Test No. 10 is a case in which A/B of an external electrode is 1, and mounting is impossible. Accordingly, A/B may be preferably less than 1, and more preferably 0.75 or less.

Accordingly, when the ratio (A/B) of the maximum size (A) of the protective portion 120 in the second direction to the maximum size (B) of the external electrode in the second direction is greater than 0.18 and less than 1.00, more preferably 0.25 or more and 0.75 or less, excellent mounting properties and moisture resistance reliability may be secured, and occurrence of a short circuit may be suppressed.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are intended to describe specific example embodiments and are not meant to limit the present disclosure. Singular terms may include plural forms unless the context clearly indicates otherwise.

What is claimed is:

1. A multilayer electronic component comprising:
a multilayer portion including a dielectric layer, an internal electrode disposed alternately with the dielectric layer in a first direction, first and second surfaces opposing each other in the first direction, third and fourth surfaces opposing each other in a second direction, perpendicular to the first direction, the third and the fourth surfaces connected to at least a portion of the internal electrode, and fifth and sixth surfaces opposing each other in a third direction, perpendicular to the first and the second directions;
a protective portion disposed on the third and the fourth surfaces; and
an external electrode disposed on the multilayer portion and the protective portion, the external electrode connected to the internal electrode,
wherein the dielectric layer includes a first dielectric grain, and the protective portion includes a second dielectric grain, and
an average size of the second dielectric grain is less than an average size of the first dielectric grain.

2. The multilayer electronic component of claim 1, wherein
one end of the internal electrode in the second direction, connected to the third surface or the fourth surface, is referred to as an end portion of the internal electrode, and a region between an uppermost end and a lowermost end of the end portion of the internal electrode in the first direction and a region between both line segments connecting a distal end of the end portion of the internal electrode in the third direction are referred to as an end surface of the internal electrode,
the protective portion covers a region of the third surface and the fourth surface, excluding the end surface of the internal electrode.

3. The multilayer electronic component of claim 2, wherein a region of the third surface and the fourth surface, not covered by the protective portion, has a rectangular shape.

4. The multilayer electronic component of claim 2, wherein a region of the third surface and the fourth surface, not covered by the protective portion, has an oval shape or a circular shape.

5. The multilayer electronic component of claim 1, wherein a ratio of an average size of the second dielectric grain to an average size of the first dielectric grain is between 0.10 and 0.8, inclusive.

6. The multilayer electronic component of claim 1, wherein a ratio of a maximum size of the protective portion in the second direction to a maximum size of the external electrode in the second direction is between 0.18 and 1.00.

7. The multilayer electronic component of claim 1, wherein a ratio of a maximum size of the protective portion in the second direction to a maximum size of the external electrode in the second direction is between 0.25 and 0.75, inclusive.

8. The multilayer electronic component of claim 1, wherein both ends of the internal electrode in the third direction are disposed to be spaced apart from the fifth surface and the sixth surface.

9. The multilayer electronic component of claim 1, wherein the internal electrode has a rectangular shape in a cross-section of the multilayer portion in the second and the third directions.

10. The multilayer electronic component of claim 1, wherein a size of the internal electrode in the third direction is substantially equal to its size in the second direction.

11. The multilayer electronic component of claim 1, wherein
the multilayer portion includes a capacitance formation portion in which the internal electrode and the dielectric layer are alternately disposed to form capacitance, and a cover portion disposed on each of both side surfaces of the capacitance formation portion in the first direction, and
an average size of the cover portion in the first direction is 0.25 times or less than a maximum size of the multilayer electronic component in the first direction.

12. The multilayer electronic component of claim 1, wherein
the multilayer portion includes a capacitance formation portion in which the internal electrode and the dielectric layer are alternately disposed to form capacitance, and a margin portion disposed on each of both side surfaces of the capacitance formation portion in the third direction, and
an average size of the margin portion in the third direction is 0.25 times or less than a maximum size of the multilayer electronic component in the third direction.

13. The multilayer electronic component of claim 1, wherein an area of a region of the third and the fourth surfaces, not covered by the protective portion, is greater than an area of a region of the third and the fourth surfaces, covered by the protective portion.

14. A multilayer electronic component comprising:
a multilayer portion including:
a dielectric layer,
internal electrodes alternately disposed with the dielectric layer in a first direction,
first and second surfaces opposing each other in the first direction,
third and fourth surfaces opposing each other in a second direction perpendicular to the first direction, and
fifth and sixth surfaces opposing each other in a third direction perpendicular to the first and second directions;
a protective portion disposed on the third and the fourth surfaces;
external electrodes disposed on the multilayer portion and the protective portion, the external electrodes being electrically connected to the internal electrodes; and
margin portions disposed on the fifth and sixth surfaces, wherein the average thickness of each of the margin portions is 0.25 times or less than a maximum size of the multilayer electronic component in the third direction.

15. The multilayer electronic component of claim 14, wherein the margin portions have a composition different from that of the dielectric layer.

16. The multilayer electronic component of claim 14, wherein the margin portions comprise a dielectric material with an average grain size smaller than that of the dielectric layer.
